(19) United States
(12) Patent Application Publication
(10) Pub. No.: US 2002/0136419 A1
(43) Pub. Date: Sep. 26, 2002

(54) Dj mixer with linearly aligned upper and lower faders

(76) Inventor: Mar Cee Santos, Las Vegas, NV (US)

Correspondence Address: Mar Santos, 1816 Eastwood Dr., Las Vegas, NV, 89104, US

(21) Appl. No.: 09/818,080

(22) Filed: Mar. 26, 2001

(51) Int. Cl. H04B 1/00

(52) U.S. Cl. 381/119

(57) ABSTRACT

A dj mixer architecture using two faders for each phono/line input channel on a dj mixer. The two faders for each phono/line input channel are linearly aligned, located above and below each other both positioned in a vertical sliding direction. Each fader, a manipulator made into a unit to be used during play in real time, has it's own specified volume curve thus each having a different manipulative effect on the same audio input channel, providing a required short distance when instantaneously transferring from the upper manipulator to the lower manipulator, or vice-versa, in order to achieve a desired manipulative effect on the same audio signal during real-time, achieving the ability to apply a broad range of desired real-time manipulative effects one might create, to a single audio signal, enabling convenient usage and/or simultaneous usage of both manipulators without being in the way of the hand on it's approach to reaching any fader on a dj mixer.

### STATEMENT REGARDING FEDERALLY SPONSORED RESEARCH OR DEVELOPMENT

Not applicable

### REFERENCE TO A MICROFICHE APPENDIX

Not applicable

### BACKGROUND OF THE INVENTION

Dj mixer architectures have traditionally had “transformer” switches or input selector switches used as “transformer” switches, a type of manipulator made into a unit to be used during play in real-time that simply cuts off an audio signal when either pressed or switched, for each audio channel input to the mixer. This created unwanted noise and “clicks” to it's assigned channel which also damaged the used selector switches, distorting the audio signal, needing constant replacement. Dj's conclusively were left with using the cross-fader to achieve “transformer” type effects and the volume fader to achieve an entirely different effect. When compared, there are more sound-manipulative combinations one might create with the cross-fader as opposed to using a push button or input selector switch. However the location of the cross-fader on present dj mixers slide horizontally different from the volume fader sliding vertically. This creates inconvenient and excessive movement when switching from the volume fader to the cross-fader, or vice-versa, being impossible to achieve desired manipulative effects when both are instananeously used to manipulate it's assigned signal during play in real-time. If a design consisted of simply placing the cross-fader as close as possible to the volume fader, the cross-fader would simply be in the way of quick access to the volume fader or vice-versa

What is desired is a dj mixer architecture cancelling the amount of inconvenient and excessive transfer from the 1st manipulator fader (cross-fader), used during play in real time, to the 2nd manipulator fader (volume fader), or vice-versa, each having a different volume curve thus a different effect on the audio signal, used during play in real-time, which are both assigned to the same audio channel input to the mixer for each program.

### BRIEF SUMMARY OF THE INVENTION

Accordingly the present invention provides a dj mixer architecture using two faders for each phono/line input channel on a dj mixer. The two faders are located above and below, positioned in a vertical sliding direction and in linear alignment with one another. Each fader, a manipulator made into a unit to be used during play in real time, has it's own specified volume curve thus having a different effect on the same audio input channel, providing a required short distance when transferring from the upper manipulator to the lower manipulator, or vice-versa, in order to achieve a desired manipulative effect on the same audio signal during real-time, when both are used instantaneously, achieving the ablility to produce desired effects on the same audio signal in real-time, which could not be done on previous dj mixers. Thus in order to apply a desired effect on the same audio signal, using two manipulators made into plural units to be used during play in real-time instantaneously, in which each have a different effect on the same audio signal, the manipulators must be positioned in a way that they are quickly accessible without blocking the hand on it's approach to reaching either manipulator.

### BRIEF DESCRIPTION OF THE SEVERAL VIEWS OF THE DRAWING

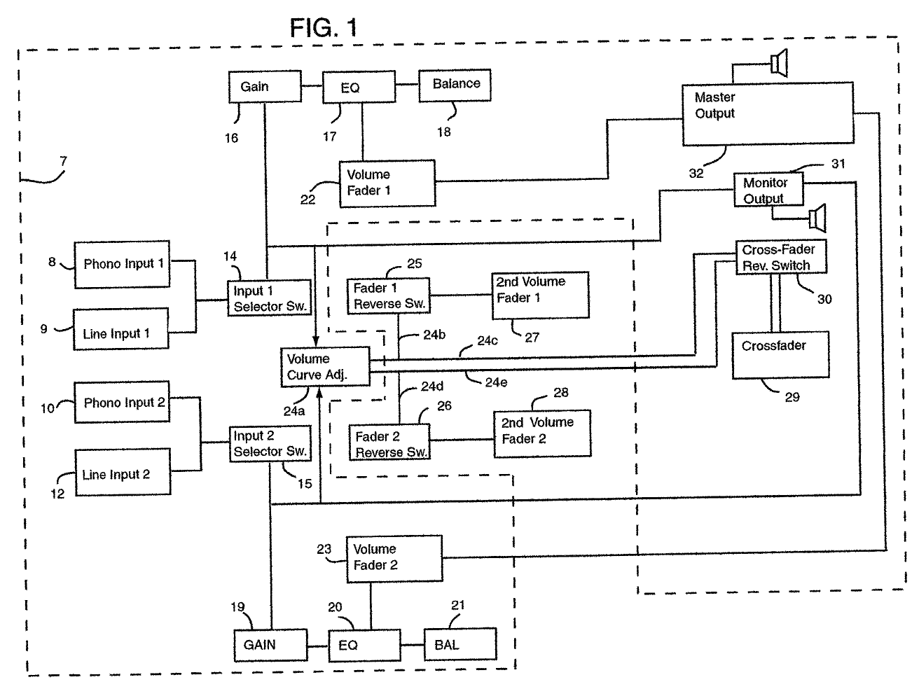

1. FIG. 1 is a block diagram of a dj mixer architecture according to the present invention.

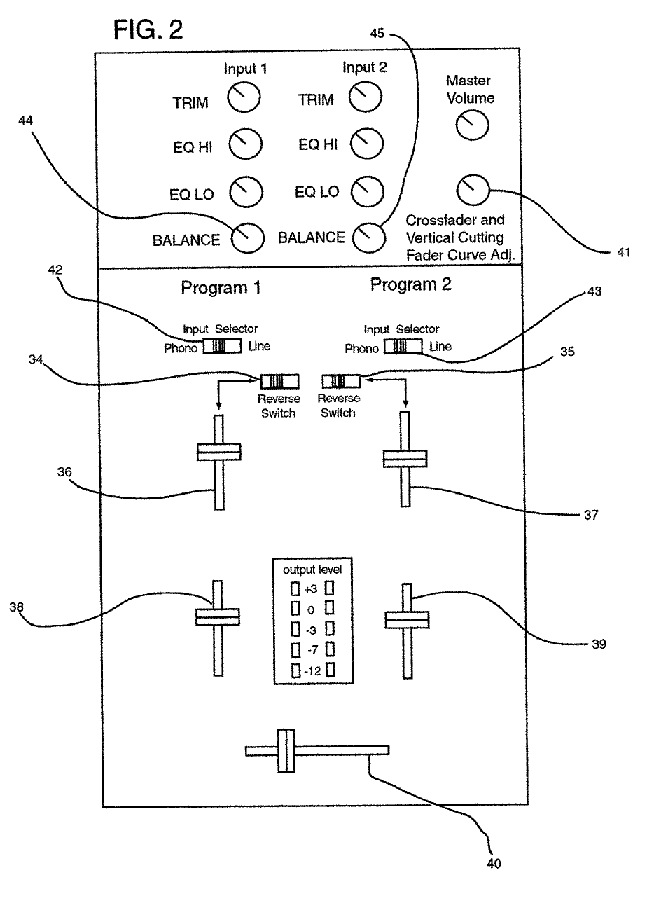

2. FIG. 2 ia a plan view of a control panel for a dj mixer according to the present invention.

### DETAILED DESCRIPTION OF THE INVENTION

Referring now to FIG. 1 two of a plurality of conventional audio input channels is shown in a conventional dj mixer design 7. The phono and standard line inputs 8, 9, 10, 12 with input selector switches 14, 15 are input to a conventional audio input channel having gain, eq and balance controls 16-21 input to conventional volume faders 22, 23. The audio signal for respective channels are also input through a volume curve adjustment 24a input to a cross-fader reverse switch 30 input to cross-fader 29. All mixed signals are controlled by master output 32 and monitored by monitor output 31.

The present invention is shown outside the dotted line 7. The respective output signals from the volume curve adjustment 24a are split for program 1 (24b, 24c) and program2 (24d, 24e). For program1 the audio signal 24b is input to a reverse switch 25 then input to the second volume fader 27. The split signal 24c is input to the cross-fader reverse switch 30 finally input to the cross-fader 29. For program2 the audio signal 24d is input to it's reverse switch 26 then input to it's second volume fader 28. The split signal for program2 (24e) is also input to the cross-fader reverse switch 30 finally input to the cross-fader 29 for mixing the two audio signals. The volume curve for 27-29 are controlled by the volume curve adjustment 24a.

FIG. 2 displays the required short-distance when instantaneously transferring from the 1st manipulators 36, 37 for each program to the 2nd manipulators 38, 39 for each program by locating the 1st manipulators 36, 37, in which the direction of movement for the audio signal to be heard may be reversed with respective switches 34, 35, approximately 4.5 centimeters directly above, in linear alignment with, the 2nd manipulators 38, 39, in order to achieve a desired manipulative effect on the same audio signal during real-time. The volume curve 41 controls faders 36, 37 and cross-fader 40 since the source of the audio signals for 36, 37 and 40 are a direct output from the crossfader curve adjustment 24a (FIG. 1) stated in the previous paragraph. Switches 34, 35, 42, 43 must be fairly short in height not to interfere with the real-time manipulative usage of the 1st manipulators 36, 37. Control knobs 44, 45 and respective knobs must be located at a distance, approximately 7 centimeters, above the top ends of the 1st manipulators 36, 37 so that they also do not interfere with the real-time manipulative usage of the 1st manipulators 36, 37.

Thus the present invention provides a dj mixer architecture cancelling the amount of inconvenient and excessive transfer from the 1st manipulator fader (cross-fader), with it's specified volume curve, used during play in real time, to the 2nd manipulator fader (volume fader), having a normal volume curve thus a different effect on the same audio signal, used during play in real-time, by adding an additional fader, interconnected with the cross-fader, having the same volume curve as the cross-fader, directly above, in linear alignment with, the volume fader, having a normal volume curve, for each phono/line input channel on a dj mixer. The additional fader for each channel has the same manipulative effect on it's applied audio signal as the cross-fader, since it has the same volume curve as the cross-fader, although its interconnection with the cross-fader is connected wherein each additional fader applies only to the audio signal the volume fader it's located directly above refers to, providing a required short distance when instantaneously transferring from the upper manipulator to the lower manipulator, or vice-versa, in order to achieve a desired manipulative effect on the same audio signal during real-time.

What is claimed is:

1. A dj mixer architecture having a means for providing a required short-distance between two manipulators used during play in real-time, when instantaneously transferring from the 1st manipulator to the 2nd manipulator, both referring to the same audio input channel for each phono/line input channel on a dj mixer, without being in the way of instantaneous access to one another, by acquiring two faders, one with it's bottom end approximately 4.5 centimeters directly above the top end of a lower fader, in linear alignment with each other, both positioned in a vertical sliding direction, for each phono/line input channel on a dj mixer, the upper fader, a manipulator made into a unit to be used during play in real-time, having a specified volume curve, the lower fader, a second manipulator made into a unit to be used during play in real-time, having a normal volume curve thus a different manipulative effect, to achieve the ability to apply desired manipulative effects one might create, to a single audio signal, when two manipulators, each having a different manipulative effect on the same audio signal are used instantaneously during real-time.
